(19) United States
(12) Patent Application Publication
(10) Pub. No.: US 2018/0376087 A1
(43) Pub. Date: Dec. 27, 2018

(54) USING THE SAME PIXELS TO CAPTURE BOTH SHORT AND LONG EXPOSURE DATA FOR HDR IMAGE AND VIDEO

(71) Applicant: QUALCOMM Incorporated, San Diego, CA (US)

(72) Inventors: Ravi Shankar Kadambala, Hyderabad (IN); Soman Nikhara, Hyderabad (IN); Bapineedu Chowdary Gummadi, Hyderabad (IN)

(21) Appl. No.: 15/892,137

(22) Filed: Feb. 8, 2018

Related U.S. Application Data
(60) Provisional application No. 62/524,300, filed on Jun. 23, 2017.

(51) Int. Cl. H04N 5/355; H04N 5/369; H04N 5/232

(52) U.S. Cl. CPC H04N 5/35581; H04N 5/23229; H04N 5/3698

(57) ABSTRACT

Systems and methods for performing HDR imaging are described. Aspects of the disclosure may include a camera system that uses the same pixels to capture both short and long exposure pixel data to improve camera hardware efficiency and pixel efficiency, and to reduce power usage by the camera system. In some aspects, exposure of a plurality of pixels available in a device may be started. Pixel data from the plurality of pixels may be captured after a first time period has elapsed to obtain short exposure pixel data. Pixel data from the plurality of pixels may also be captured after a second time period, longer than the first time period, has elapsed to obtain long exposure pixel data. The short exposure pixel data and the long exposure pixel data may be processed to create HDR images and/or videos.

### CROSS-REFERENCE TO RELATED APPLICATIONS

This application claims the benefit of U.S. Provisional Patent Application No. 62/524,300, entitled “USING THE SAME PIXELS TO CAPTURE BOTH SHORT AND LONG EXPOSURE DATA FOR HDR IMAGE AND VIDEO,” filed on Jun. 23, 2017, which is expressly incorporated by reference herein in its entirety.

### FIELD

Aspects of the present disclosure relate generally to high dynamic range (HDR) imaging. More particularly, certain aspects of the technology discussed below relate to using the same pixels to capture both short and long exposure data for HDR image and video.

### BACKGROUND

To capture HDR images and video, multiple exposures of an image are typically combined. Usually, short exposure pixel data is combined with long exposure pixel data. Because the capturing device, e.g., a camera system, that is used to obtain both the short exposure pixel data and the long exposure pixel data typically has a finite maximum pixel resolution, a finite maximum number of pixels are typically available to obtain the short exposure pixel data and the long exposure pixel data. Therefore, efficient use by camera systems of the pixels and the exposures is essential to obtaining high-quality images and video without using significant hardware resources and power.

Some conventional camera systems obtain the short and long exposure data by: (a) dedicating a first set of pixels, e.g., half of the maximum available, for short exposure data and dedicating a second set of pixels, e.g., the remaining half of the maximum available, different from the first set of pixels, for long exposure data, (b) exposing the first set of pixels for a short time to obtain short exposure data, and (c) exposing the second set of pixels for a longer time to obtain long exposure data. Other conventional camera systems obtain the short and long exposure data by: (a) dedicating a first set of pixel rows for short exposure data and dedicating a second set of pixel rows, different from the first set of pixel rows, for long exposure data, (b) exposing the first set of pixel rows for a short time to obtain short exposure data, and (c) exposing the second set of pixel rows for a longer time to obtain long exposure data.

Conventional camera systems suffer from numerous drawbacks. For example, in conventional camera systems, pixels or rows of pixels dedicated for obtaining short exposure data for an image are not used to obtain long exposure data for the image and pixels or rows of pixels dedicated for obtaining long exposure data for the image are not used to obtain short exposure data for the image. Thus, after the short and long exposure data is combined, the maximum resolution that such conventional camera systems may obtain is approximately half the total number of pixels available because only approximately half of the pixels or rows of pixels are used to obtain short exposure data while the other half of the pixels or rows of pixels are used to obtain long exposure data. Therefore, in order to obtain a desired resolution for an HDR image, twice as many pixels as the desired resolution are needed. Not only is such a result inefficient, but it also requires more power usage and more hardware resources, which as a result leads to higher costs. Accordingly, conventional camera systems are less than optimal.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of HDR imaging is provided. The method can include starting, by a processor, exposure of a plurality of pixels available in a device. The method can also include capturing, by the processor, pixel data from the plurality of pixels after a first time period has elapsed to obtain short exposure pixel data. The method can further include capturing, by the processor, pixel data from the plurality of pixels after a second time period, longer than the first time period, has elapsed to obtain long exposure pixel data.

In another aspect of the disclosure, an apparatus configured for performing HDR imaging is provided. For example, the apparatus can include means for starting exposure of a plurality of pixels available in a device. The apparatus can also include means for capturing pixel data from the plurality of pixels after a first time period has elapsed to obtain short exposure pixel data. The apparatus can further include means for capturing pixel data from the plurality of pixels after a second time period, longer than the first time period, has elapsed to obtain long exposure pixel data.

In still another aspect of the disclosure, a non-transitory computer-readable medium having program code recorded thereon for performing HDR imaging is provided. The program code can include program code executable by a computer for causing the computer to start exposure of a plurality of pixels available in a device. The program code can also include program code executable by a computer for causing the computer to capture pixel data from the plurality of pixels after a first time period has elapsed to obtain short exposure pixel data. The program code can further include program code executable by a computer for causing the computer to capture pixel data from the plurality of pixels after a second time period, longer than the first time period, has elapsed to obtain long exposure pixel data.

In yet another aspect of the disclosure, an apparatus configured for performing HDR imaging is provided. The apparatus includes a memory and at least one processor coupled to the memory. The at least one processor can be configured to start exposure of a plurality of pixels available in a device. The at least one processor can also be configured to capture pixel data from the plurality of pixels after a first time period has elapsed to obtain short exposure pixel data. The at least one processor can be further configured to capture pixel data from the plurality of pixels after a second time period, longer than the first time period, has elapsed to obtain long exposure pixel data.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and/or a second label that distinguishes among the similar components. If just the first reference label is used in the specification, the description is applicable to any one of the similar components having the same first reference label irrespective of the second reference label.

FIG. 1 shows a block diagram of a computing device with a camera system according to aspects of the present disclosure.

FIG. 2 shows a flow diagram for using the same pixels to capture both short and long exposure data for HDR imaging according to aspects of the present disclosure.

FIG. 3A shows an example pixel array and timing diagram that illustrates the timing of pixel exposure and pixel data capture according to aspects of the present disclosure.

FIG. 3B shows another example pixel array and timing diagram that illustrates the timing of pixel exposure and pixel data capture according to aspects of the present disclosure.

### DETAILED DESCRIPTION

The detailed description set forth below, in connection with the appended drawings, is intended as a description of various possible configurations and is not intended to limit the scope of the disclosure. Rather, the detailed description includes specific details for the purpose of providing a thorough understanding of the inventive subject matter. It will be apparent to those skilled in the art that these specific details are not required in every case.

Aspects of the disclosure may yield improved camera systems for the capture of HDR images and video. For example, aspects of the disclosure may include a camera system that uses the same pixels to capture both short and long exposure pixel data to improve camera hardware efficiency and pixel efficiency, and to reduce power usage by the camera system.

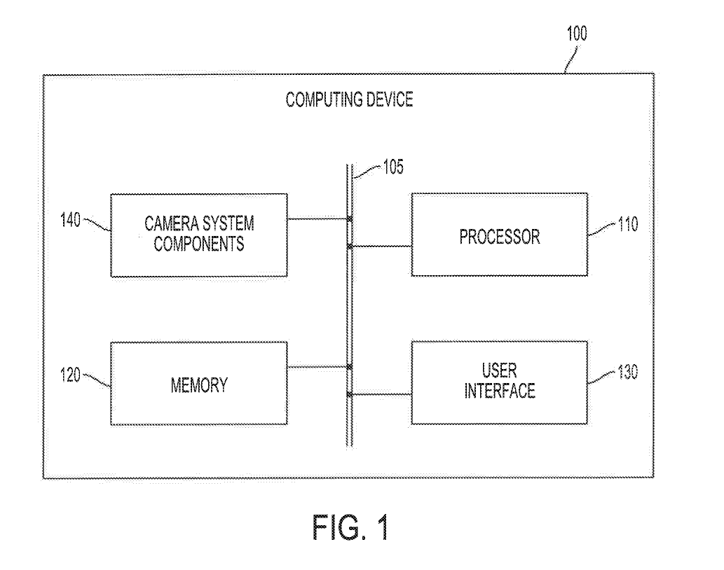

FIG. 1 shows a block diagram of a computing device 100 with a camera system according to aspects of the present disclosure. As an example, and not limitation, device 100 may be a portable personal computing device, e.g., a mobile phone, a smartphone, a still camera, a video camera, a digital camera, a tablet computer, a laptop computer, a personal digital assistant, a wearable computing device, a home automation component, a digital video recorder, a digital television, a remote control, or some other type of device equipped with at least some image capture and/or image processing capabilities. Device 100 may also be a stationary computing device or any other device, such as a wireless communication device, used to obtain HDR images or video. In aspects of this disclosure, device 100 may be referred to as a camera device. A plurality of applications that may utilize the HDR imaging techniques disclosed herein may be available to the user of device 100. It should be understood that device 100 may represent a physical camera device such as a digital camera, a particular physical hardware platform on which a camera application operates in software, or other combinations of hardware and software that are configured to carry out camera functions.

As shown in FIG. 1, device 100 may include a processor 110, a memory 120, a user interface 130, and the camera system components 140 (also referred to as camera system 140), all of which may be communicatively linked together by a system bus, network, or other connection mechanism 105. Processor 110 may include a single multi-purpose processor, multiple processors operating in parallel, multiple processors performing different operations, or a combination of multiple processors operating in parallel and multiple processors performing different operations. For example, processor 110 may be configured to execute instructions to control the camera system 140, to perform image/video processing, and to perform various other operations to control aspects of device 100 and/or to process data within device 100. Processor 110 may include one or more general purpose processors, e.g., microprocessors, and/or one or more special purpose processors, e.g., digital signal processors (DSPs), graphics processing units (GPUs), floating point units (FPUs), network processors, or application-specific integrated circuits (ASICs). In some instances, special purpose processors may be image processors capable of image processing, image alignment, and merging images, among other possibilities.

Memory 120 may include various types of volatile and/or non-volatile memory media for the storage of various types of information. For example, memory 120 may include a disk drive, e.g., a floppy disk drive, a hard disk drive, an optical disk drive, or a magneto-optical disk drive, or may include a solid state memory, e.g., a FLASH memory, RAM, ROM, and/or EEPROM. Memory 120 may also include multiple memory units, any of which may be configured to be within device 100 or to be external to device 100. For example, memory 120 may include a ROM memory containing system program instructions stored within device 100. Memory 120 may also include memory cards or high speed memories configured to store captured images which may be removable from device 100. Memory 120 can also be external to device 100, and in one example device 100 may wirelessly transmit data to memory 120, for example over a network connection. Memory 120 may include removable and/or non-removable components.

Memory 120 may be configured to store various types of information. For example, memory 120 may store data, such as image or video data obtained from camera system components 140, data associated with an operating system of device 100, and/or data associated with applications that may run on device 100. Memory 120 may also include program instructions that processor 110 may execute to perform processing related to applications, the operating system, and/or to control camera system components 140. By way of example, program instructions stored in memory 120 may include an operating system, e.g., an operating system kernel, device driver(s), and/or other modules, and one or more application programs, e.g., camera functions, address book, email, web browsing, social networking, and/or gaming applications, installed on device 100.

Processor 110 may execute instructions from memory 120 or process data stored in memory 120. For example, processor 110 may be capable of executing program instructions, e.g., compiled or non-compiled program logic and/or machine code, stored in memory 120 to carry out the various functions described herein. Therefore, memory 120 may include a non-transitory computer-readable medium, having stored thereon program instructions that, upon execution by computing device 100, cause computing device 100 to carry out any of the methods, processes, or functions disclosed in this specification and/or the accompanying drawings. The execution of program instructions by processor 110 may result in processor 110 using data within memory 120.

User interface 130 may function to allow device 100 to interact with a human or non-human user, such as to receive input from a user and to provide output to the user. Thus, user interface 130 may include input components such as a keypad, keyboard, touch-sensitive or presence-sensitive panel, computer mouse, trackball, joystick, microphone, and so on. User interface 130 may also include one or more output components such as a display screen which, for example, may be combined with a presence-sensitive panel. The display screen may be based on cathode ray tube (CRT), liquid crystal (LCD), light emitting diode (LED), and/or plasma technologies, or other technologies now known or later developed. In some aspects, user interface 130 may display, for example through a display screen, a digital representation of the current image being captured by device 100, or an image that could be captured or was recently captured by device 100. Thus, user interface 130 may serve as a viewfinder for camera system 140 of device 100. For example, in some aspects, user interface 130 may include a display that serves as a viewfinder for still camera and/or video camera functions supported by computing device 100. In some aspects, a display screen of user interface 130 may also support touchscreen and/or presence-sensitive functions that may be able to adjust the settings and/or configuration of any aspect of camera system 140. Additionally, user interface 130 may include one or more buttons, switches, knobs, and/or dials that facilitate the configuration and focusing of a camera function and the capturing of images, e.g., capturing a picture. It may be possible that some or all of these buttons, switches, knobs, and/or dials are implemented as functions on a presence-sensitive panel. User interface 130 may also be configured to generate audible output(s), via a speaker, speaker jack, audio output port, audio output device, earphones, and/or other similar devices.

Camera system components 140 may include, but are not limited to, an aperture through which light enters, a shutter to control how long light enters through the aperture, a recording surface for capturing the image represented by the light, and/or a lens positioned in front of the aperture to focus at least part of the image on the recording surface. The aperture may be fixed size or adjustable. The recording surface may include an electronic image sensor to transfer and/or store captured images in memory. The electronic image sensor may include an array of photosensitive elements for converting incident light into electric signals. For example, an electronic image sensor may include a charge coupled device (CCD), a complementary metal-oxide-semiconductor (CMOS) sensor, or any other image sensing device that receives light and generates image data in response to the received light.

The shutter may be coupled to or nearby the lens or the recording surface. The shutter may either be in a closed position, in which it blocks light from reaching the recording surface, or an open position, in which light is allowed to reach to recording surface. In some aspects, the position of the shutter may be controlled by a shutter button. For instance, the shutter may be in the closed position by default. When the shutter button is triggered (e.g., pressed), the shutter may change from the closed position to the open position for a period of time, known as the shutter cycle. During the shutter cycle, an image may be captured on the recording surface. At the end of the shutter cycle, the shutter may change back to the closed position. Alternatively, the shuttering process may be electronic. For example, before an electronic shutter of a CCD image sensor or CMOS image sensor is “opened” the sensor may be reset to remove any residual signal in its photosensitive elements. While the electronic shutter remains open, the photosensitive elements may convert incident light into electrical signals so that an image may be captured on the recording surface. When, or after the shutter closes, these electrical signals may be transferred to longer-term memory. Combinations of mechanical and electronic shuttering may also be possible.

Regardless of the type of shutter, a shutter may be activated and/or controlled by something other than a shutter button. For instance, the shutter may be activated and/or controlled by processor 110, a softkey, a timer, or some other trigger. Herein, the term “image capture” may refer to any mechanical and/or electronic shuttering process that results in one or more images being recorded, regardless of how the shuttering process is triggered or controlled. For example, a still camera may capture one or more images each time image capture is triggered. A video camera may continuously capture images at a particular rate, e.g., images—or frames—per second, as long as image capture remains triggered. That is, captured images may be a single image, a plurality of still images, or a video stream.

The exposure of a captured image may be determined by a combination of the size of the aperture, the brightness of the light entering the aperture, and the length of the shutter cycle (also referred to as the shutter length or the exposure length). Herein, the term “exposure time” or its variants, may be interpreted as possibly referring to a shutter length, an exposure time, e.g., the length of time of an exposure, or any other metric that controls the amount of signal response that results from light reaching the recording surface.

Although FIG. 1 depicts a device 100 having separate components, one skilled in the art would recognize that these separate components may be combined in a variety of ways to achieve particular design objectives. For example, in an alternative aspect, the memory components 120 may be combined with processor components 110, for example to save cost and/or to improve performance.

In some aspects, any of the camera system components 140 and the exposure time may be controlled by processor 110. For example, camera system components 140 may be controlled, at least in part, by processor 110 upon execution by processor 110 of software. In particular, cameras may include software to control one or more camera functions and/or settings, such as exposure time, aperture size, and so on. For example, image capture by device 100 may be triggered by processor 110, as well as by some other mechanism, such as by activating a shutter button, by pressing a softkey on user interface 130, or by some other mechanism. In some aspects, the software processor 110 may execute to control camera system components 140 may include some data and/or program instructions stored in memory 120.

According to some aspects, camera device 100 may be used for HDR imaging. For example, to capture HDR images and video, camera device 100 may be configured to combine data from multiple exposures of an image. As an example, camera device 100 may combine short exposure pixel data with long exposure pixel data. In some aspects, camera device 100 may be configured to use the same pixels to capture both short and long exposure pixel data to improve camera hardware efficiency and pixel efficiency, and to reduce power usage by the camera system.

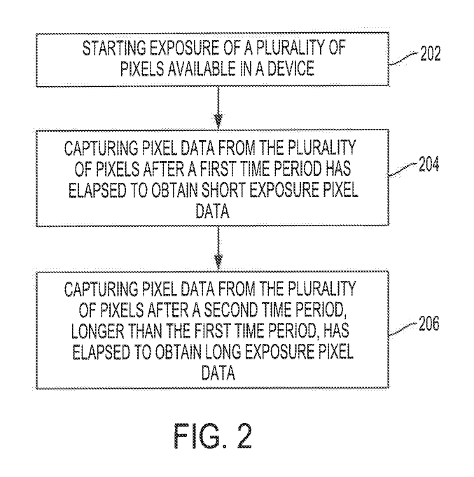

FIG. 2 shows a flow diagram for using the same pixels to capture both short and long exposure data for HDR imaging according to aspects of the present disclosure. Aspects of method 200 may be implemented with the aspects of this disclosure described with respect to FIG. 1. Specifically, method 200 includes, at block 202, starting exposure of a plurality of pixels available in a device. For example, device 100, under control of processor 110, may be configured to start exposure of a plurality of pixels available in camera system 140 of device 100. At block 204, method 200 includes capturing pixel data from the plurality of pixels after a first time period has elapsed to obtain short exposure pixel data. For example, device 100, under control of processor 110, may be configured to capture pixel data from the plurality of pixels after a first time period has elapsed to obtain short exposure pixel data. At block 206, method 200 includes capturing pixel data from the plurality of pixels after a second time period, longer than the first time period, has elapsed to obtain long exposure pixel data. For example, device 100, under control of processor 110, may be configured to capture pixel data from the plurality of pixels after a second time period, longer than the first time period, has elapsed to obtain long exposure pixel data.

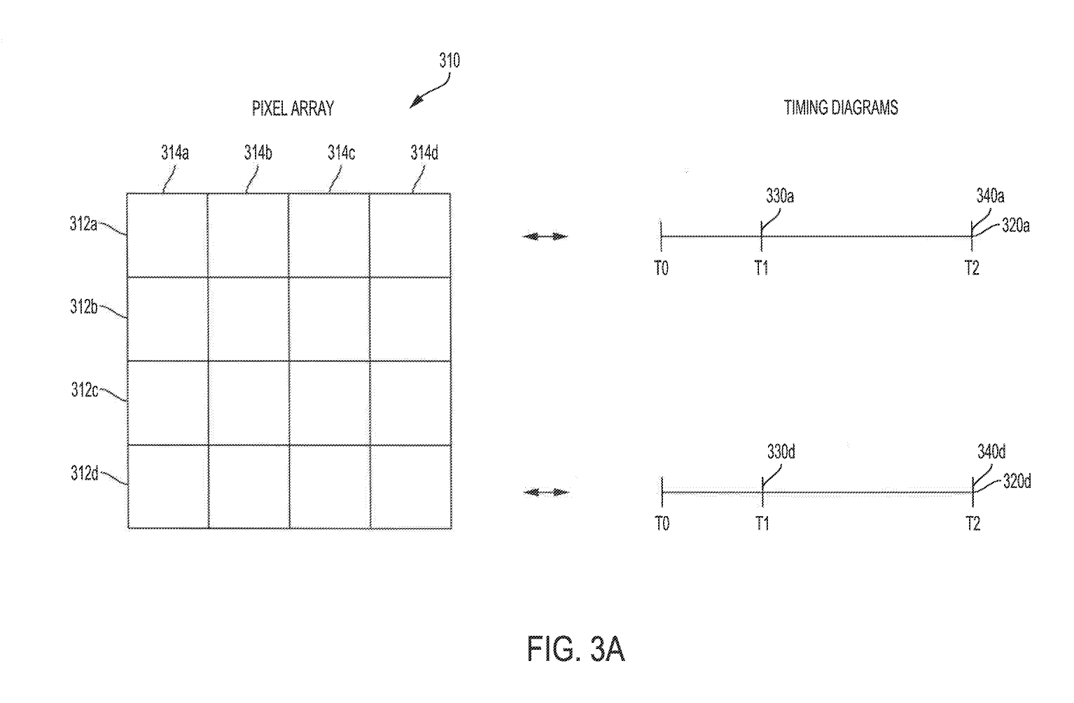

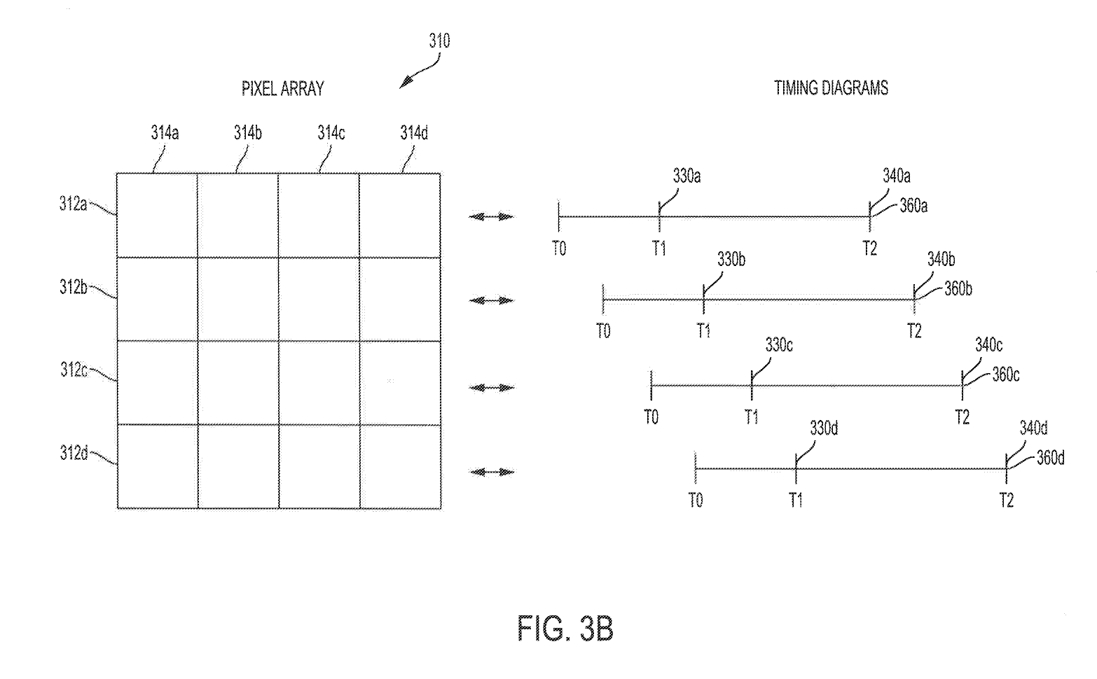

FIG. 3A shows an example pixel array and timing diagram that illustrates the timing of pixel exposure and pixel data capture according to aspects of the present disclosure, such as the aspect disclosed in method 200. As illustrated in FIG. 3A, a plurality of pixels may include a pixel array 310 having rows 312a-d and columns 314a-d of pixels. The pixel array illustrated in FIG. 3A is provided only for illustrative purposes, as one of skill in the art would readily understand that a pixel array may include more or less than four rows, more or less than four columns, and need not be two-dimensional, e.g., pixel array may be three-dimensional, four-dimensional, and so on.

In some aspects, pixel array 310 may correspond to the recording surface described with reference to FIG. 1 on which an image is captured. For example, the value of a pixel in pixel array 310 may correspond to one or more values representing electrical signals obtained via one or more photosensitive elements of the recording surface. In other words, a pixel in pixel array 310 may correspond to a digital value that is representative of one or more electrical signals present on one or more of the photosensitive elements of the recording surface after the photosensitive elements of the recording surface have been exposed to light and have converted the incident light to the electrical signals. Therefore, in some aspects, starting exposure of a plurality of pixels, such as at block 202 of method 200, may refer to the starting of light capture by the photosensitive elements of the recording surface and the corresponding encoding of respective pixels with digital values for brightness and/or color.

Captured images may be represented as a one-dimensional, two-dimensional, or multi-dimensional array of pixels. For example, in the aspects illustrated in FIG. 3A, captured images are represented as a two-dimensional pixel array 310. Each pixel may be represented by one or more values that may encode the respective pixel's color and/or brightness. In some aspects, possible pixel encodings may be based on one or more of various color models, such as RGGB, RGBN, RGB, CMYK, YCbCr, YUV, and YIQ, as well as other encodings now known or later developed. Further, the pixels in an image may be represented in various file formats, including raw (uncompressed) formats, or compressed formats such as Joint Photographic Experts Group (PEG), Portable Network Graphics (PNG), Graphics Interchange Format (GIF), and so on.

In some aspects, each of the color and brightness channels may be associated with a value representative of the color or brightness. Thus, the brightness of a pixel may be represented by a 0 or a value near 0 if the pixel is black or close to black, and by a maximum value or a value near maximum if the pixel is white or close to white. For example, if each of the color and/or brightness channels are represented by 8 bits, a black or close to black pixel may have a value of 0 or a value near 0, and a white or close to white pixel may have a value of 255 or a value near 255. Similarly, if each of the color and/or brightness channels are represented by 10 bits, a black or close to black pixel may have a value of 0 or a value near 0, and a white or close to white pixel may have a value of 1023 or a value near 1023. In other aspects, the pixel value may be flipped such that a value near 0 is associated with near-white pixel, and a near-maximum value is associated with a near-black pixel.

According to some aspects, the brightness of a pixel, and therefore the brightness value associated with a pixel, may be a function of the exposure time of the pixel. For example, a short exposure time for pixels may result in a reasonably accurate representation of the bright regions of a scene. Conversely, a long exposure time for pixels may result in a reasonably accurate representation of the dark regions of a scene.

In the aspect illustrated in FIG. 3A, timing diagrams 320a and 320d illustrate how a camera system may be controlled in accordance with aspects of this disclosure to use the same pixels to capture both short and long exposure data for HDR imaging. One of skill in the art would readily understand that while only timing diagrams 320a and 320d are provided in FIG. 3A for illustrative purposes only, in general, each row 312a-d may be associated with a distinct timing diagram 320a-d. In some aspects, a camera device may be configured, for example, with a processor 110 of the camera device 100 of FIG. 1, to determine a long exposure time T2 for all the pixels of pixel array 310. For example, long exposure time T2 may be set to an exposure time that results in pixel values that are a reasonably accurate representation of dark regions in the image to be captured. The value to which long exposure time T2 is set may vary for different image captures based on various factors, such as the desired quality for the image to be captured, the dynamic range of the brightness of the image to be captured, and/or metrics used by the camera device to determine long exposure time T2, such as pixel value averages, thresholds for pixel values, and/or weights assigned to pixels in a pixel array. Therefore, what is considered a long exposure time T2 that results in pixel values that are a reasonably accurate representation of dark regions may vary based on various factors, such as the foregoing factors mentioned for the determination of long exposure time T2. In some aspects, long exposure time T2 may be user-specified, for example by a user providing input on the camera device. In other aspects, long exposure time T2 may be determined by the camera device and a user may modify the device-determined long exposure time T2.

Similarly, a camera device may be configured, for example, with a processor 110 of the camera device 100 of FIG. 1, to determine a short exposure time T1 for all the pixels of pixel array 310. For example, short exposure time T1 may be set to an exposure time that results in pixel values that are a reasonably accurate representation of bright regions in the image to be captured. The value to which short exposure time T1 is set may vary for different image captures based on various factors, such as the desired quality for the image to be captured, the dynamic range of the brightness of the image to be captured, and/or metrics used by the camera device to determine short exposure time T1, such as pixel value averages, thresholds for pixel values, and/or weights assigned to pixels in a pixel array. Therefore, what is considered a short exposure time T1 that results in pixel values that are a reasonably accurate representation of bright regions may vary based on various factors, such as the foregoing factors mentioned for the determination of short exposure time T1. In some aspects, short exposure time T1 may be user-specified, for example by a user providing input on the camera device. in other aspects, short exposure time T1 may be determined by the camera device and a user may modify the device-determined short exposure time T1. Referring to method 200, short exposure time T1 may refer to the first time period disclosed at block 204, and long exposure time T2 may refer to the second time period that is longer than the first time period, as disclosed at 206.

According to some aspects, the values for short exposure time T1 and long exposure time T2 may be determined based, at least in part, on a frame rate, which may be expressed as frames per second (FPS), associated with the camera device. For example, according to some aspects, a camera device may be configured to maintain a minimum frame rate FPSₘᵢₙ. In some aspects, the camera device may be configured to set the long exposure time T2 to a value that is less than 1/(FPSₘᵢₙ). As an example, and not limitation, a camera device may be configured to maintain a minimum frame rate of 15 FPS. Based on that minimum frame rate of 15 FPS, the camera device may set the maximum value of long exposure time T2 to a value of 66.66 ms. In other aspects, the camera device may set long exposure time T2 to a value less than 66.66 ms, such as 65 ms, 60 ms, 50 ms, and so on. For example, the camera device may set long exposure time T2 to a value less than 66.66 ms to meet a particular camera specification. According to some aspects, short exposure time T1 may be determined in a manner similar to the manner in which long exposure time T2 is determined. For example, the camera device may be configured to set the short exposure time T1 to a value that is less than 1/(FPSₘᵢₙ). As an additional constraint on short exposure time T1, the camera device may be configured to set short exposure time T1 to a value that is less than whatever value long exposure time T2 is set. In some aspects, short exposure time T1 may be a fraction of long exposure time T2, although in general short exposure time T1 need not be a fraction of long exposure time T2. In other aspects, short exposure time T1 may be set to meet a particular camera specification.

In some aspects, the camera device may be configured, for example, with a processor 110 of the camera device 100 of FIG. 1, to determine the values for short exposure time T1 and long exposure time T2 based, at least in part, on an analysis of the scene for which an image or video is to be captured. For example, a camera device may be configured to implement a scene analysis algorithm that analyzes the scene for which an image or video is to be captured and then determines appropriate values for short exposure time T1 and long exposure time T2 that result in reasonably accurate representations of the bright regions and the dark regions, respectively, of the scene. In some aspects, a scene analysis algorithm may include an analysis of a histogram associated with the scene.

Referring back to timing diagrams 320a and 320d, at time T0, a camera device may, for example under control of a processor, start exposure of pixel array 310, such as at block 202 of method 200. For example, at time T0, a camera device may control a shutter of the camera device and/or an aperture of the camera device to allow light to reach the photosensitive elements of the recording surface of the camera device that corresponds to pixel array 310. Upon the starting of exposure, pixels in pixel array 310 may begin to be encoded with values for brightness and/or color. For example, pixel array 310 may correspond to the recording surface described with reference to FIG. 1 on which an image is captured. In other words, the value of a pixel in pixel array 310 may correspond to one or more values representing electrical signals obtained via one or more photosensitive elements of the recording surface. Therefore, in some aspects, starting exposure of a plurality of pixels, such as at block 202 of method 200, may refer to the starting of light capture by the photosensitive elements of the recording surface, for example by controlling a shutter of the camera device and/or an aperture of the camera device to allow light to reach the photosensitive elements of the recording surface, and the corresponding encoding of respective pixels with values for brightness and/or color based on the electrical signals on the photosensitive elements of the recording surface that result from the conversion of light to electrical signals by the photosensitive elements of the recording surface.

After starting exposure of the pixels in pixel array 310, a camera device may, for example under control of a processor, capture pixel data after short exposure time T1 has elapsed since time T0 to obtain short exposure pixel data, such as at block 204 of method 200. In particular, at point 330 (e.g., 330a, 330d) of timing diagram 320 (e.g., 320a, 320d), only short exposure time T1 has elapsed since time T0. Therefore, the values for all pixels of pixel array 310 may provide short exposure pixel data. Thus, upon the elapsing of short exposure time T1, such as at points 330a, 330d of timing diagrams 320a, 320d, the camera device may capture short exposure pixel data, for example under control of a processor, by reading out all of the pixel values of pixel array 310 and storing them, for example in memory of the camera device. The pixel values captured after short exposure time T1 has elapsed, i.e., the pixel values read from pixel array 310 at points 330a, 330d of timing diagrams 320a, 320d, may therefore provide the short exposure pixel data disclosed at block 204 of method 200.

Similarly, as disclosed at block 206 of method 200, the camera device may also, for example under control of a processor, capture pixel data after long exposure time T2 has elapsed since time T0 to obtain long exposure pixel data. In particular, at point 340 (e.g., 340a, 340d) of timing diagram 320 (e.g., 320a, 320d), long exposure time T2 has elapsed since time T0. Therefore, the values for all pixels of pixel array 310 may provide long exposure pixel data. Thus, upon the elapsing of long exposure time T2, such as at points 340a, 340d of timing diagrams 320a, 320d, the camera device may capture long exposure pixel data, for example under control of a processor, by reading out all of the pixel values of pixel array 310 and storing them, for example in memory of the camera device. The pixel values captured after long exposure time T2 has elapsed, i.e., the pixel values read from pixel array 310 at points 340a, 340d of timing diagrams 320a, 320d, may therefore provide the long exposure pixel data disclosed at block 206 of method 200.

According to some aspects, pixel data may be captured, such as at block 204 and/or block 206 of method 200, one row at a time. For example, in FIG. 3B described next, pixel data from row 312a may be read out before pixel data from row 312c is read out. In other aspects, pixel data may be read out from all the pixels as opposed to one row at a time. For example, in FIG. 3A, pixel data from all rows 312a-d may be read out at time 330 (e.g., 330a, 330d) and/or 340 (e.g., 340a, 340d) of timing diagrams 320.

FIG. 3B shows another example pixel array and timing diagram that illustrates the timing of pixel exposure and pixel data capture according to aspects of the present disclosure, such as the aspect disclosed in method 200. In the aspect illustrated in FIG. 3B, timing diagrams 360 illustrate how a camera system may be controlled in accordance with aspects of this disclosure to use the same pixels to capture both short and long exposure data for HDR imaging. As with FIG. 3A, the pixel array illustrated in FIG. 3B is provided only for illustrative purposes, as one of skill in the art would readily understand that a pixel array may include more or less than four rows, more or less than four columns, and need not be two-dimensional, e.g., a pixel array may be three-dimensional, four-dimensional, and so on.

In timing diagrams 360 (e.g., 360a-360d), at times T0, a camera device may, for example under control of a processor, start exposure of respective rows 312 of pixel array 310, such as at block 202 of method 200. For example, at time T0 of timing diagram 360a, a camera device may control a shutter of the camera device and/or an aperture of the camera device to allow light to reach the photosensitive elements of the recording surface of the camera device that corresponds to row 312a of pixel array 310. Similarly, at time T0 of timing diagram 360d, a camera device may control a shutter of the camera device and/or an aperture of the camera device to allow light to reach the photosensitive elements of the recording surface of the camera device that corresponds to row 312d of pixel array 310. Upon the starting of exposure in a particular row 312, pixels in a particular row 312 of pixel array 310 may begin to be encoded with values for brightness and/or color, as described with respect to FIG. 3A. Therefore, in some aspects, starting exposure of a plurality of pixels, such as at block 202 of method 200, may refer to the starting of light capture by the photosensitive elements of one or more rows 312 of the recording surface 310 and the corresponding encoding of respective pixels in the one or more rows 312 with values for brightness and/or color.

After starting exposure of the pixels in pixel array 310 of FIG. 3B, a camera device may, for example under control of a processor, capture pixel data after short exposure times T1 have elapsed since times T0 to obtain short exposure pixel data, such as at block 204 of method 200. In particular, at point 330a of timing diagram 360a, only short exposure time T1 has elapsed since time T0. Therefore, for example, the values for all pixels of row 312a of pixel array 310 may provide short exposure pixel data. Thus, upon the elapsing of short exposure time T1, such as, for example, at point 330c of timing diagram 360c, the camera device may capture short exposure pixel data, for example under control of a processor, by reading out all of the pixel values of the pixels in row 312c of pixel array 310 and storing them, for example in memory of the camera device. The pixel values captured after short exposure time T1 has elapsed, i.e., the pixel values read from the pixels in row 312c of pixel array 310 at point 330c of timing diagram 360c, may therefore provide the short exposure pixel data disclosed at block 204 of method 200.

Similarly, as disclosed at block 206 of method 200, the camera device may also, for example under control of a processor, capture pixel data after long exposure times T2 have elapsed since time T0 to obtain long exposure pixel data. In particular, at point 340a of timing diagram 360a, long exposure time T2 has elapsed since time T0. Therefore, for example, the values for all pixels of row 312a of pixel array 310 may provide long exposure pixel data. Thus, upon the elapsing of long exposure time T2, such as, for example, at point 340c of timing diagram 360c, the camera device may capture long exposure pixel data, for example under control of a processor, by reading out all of the pixel values of the pixels in row 312c of pixel array 310 and storing them, for example in memory of the camera device. The pixel values captured after long exposure time T2 has elapsed, i.e., the pixel values read from the pixels in row 312c of pixel array 310 at point 340c of timing diagram 360c, may therefore provide the long exposure pixel data disclosed at block 206 of method 200.

In some aspects, regardless of whether exposure of pixels is started at the same time, as illustrated in FIG. 3A, or exposure of pixels is started at different times for different rows, as illustrated in FIG. 3B, the pixel data from the pixel array 310 may be read out one row at a time. For example, in one aspect, pixel data from row 312a may be read out first, followed by the reading out of pixel data from row 312b, and so on. In some aspects, such reading out of pixels may be referred to as rolling shutter read out. Accordingly, when a read out time arrives, such as time T1 in FIG. 3A or 3B to read out short exposure pixel data or time T2 in FIG. 3A or 3B to read out long exposure pixel data, all the pixel data for a particular row may be read out at the same time in parallel.

As a specific example of the rolling shutter read out process when exposure of pixels is started at the same time as illustrated in FIG. 3A, after short exposure time T1 has elapsed all pixels in the entire pixel array 310 illustrated in FIG. 3A may contain short exposure pixel data. Using the rolling shutter read out process, immediately after short exposure time T1 has elapsed all of the pixel values of the pixels in row 312a may be read out first, followed by the read out of all of the pixel values of the pixels in row 312b, followed by the read out of all of the pixel values of the pixels in row 312c, and so on. Similarly, after long exposure time T2 has elapsed all pixels in the entire pixel array 310 illustrated in FIG. 3A may contain long exposure pixel data. Using the rolling shutter read out process, immediately after long exposure time T2 has elapsed all of the pixel values of the pixels in row 312a may be read out first, followed by the read out of all of the pixel values of the pixels in row 312b, followed by the read out of all of the pixel values of the pixels in row 312c, and so on.

As a specific example of the rolling shutter read out process when exposure of pixels is started at different times for different rows as illustrated in FIG. 3B, after short exposure time T1 for row 312a in FIG. 3B has elapsed, identified by location 330a on timing diagram 360a, all pixels in row 312a of pixel array 310 illustrated in FIG. 3B may contain short exposure pixel data. Using the rolling shutter read out process, immediately after short exposure time T1 identified by location 330a has elapsed all of the pixel values of the pixels in row 312a may be read out first. A short time later, after short exposure time T1 for row 312b in FIG. 3B has elapsed, identified by location 330b on timing diagram 360b, all pixels in row 312b of pixel array 310 illustrated in FIG. 3B may contain short exposure pixel data and all of the pixel values of the pixels in row 312b may be read out. The process may continue successively for each subsequent row until the short exposure pixel data has been read out from every row in the pixel array 310 illustrated in FIG. 3B.

Similarly, after long exposure time T2 for row 312a in FIG. 3B has elapsed, identified by location 340a on timing diagram 360a, all pixels in row 312a of pixel array 310 illustrated in FIG. 3B may contain long exposure pixel data. Using the rolling shutter read out process, immediately after long exposure time T2 identified by location 340a has elapsed all of the pixel values of the pixels in row 312a may be read out first. A short time later, after long exposure time T2 for row 312b in FIG. 3B has elapsed, identified by location 340b on timing diagram 360b, all pixels in row 312b of pixel array 310 illustrated in FIG. 3B may contain long exposure pixel data and all of the pixel values of the pixels in row 312b may be read out. The process may continue successively for each subsequent row until the long exposure pixel data has been read out from every row in the pixel array 310 illustrated in FIG. 3B.

According to some aspects, camera system components 140 of computing device 100 of FIG. 1 may further include one or more latches and one or more analog-to-digital converters (ADCs) for performing the pixel read out process. For example, in one aspect, every row of pixel array 310 may be associated with two latches and one ADC. In such an aspect, when a short exposure time T1 is reached for a particular row, such as, for example, row 312a, the pixel data in each of the pixels of row 312a may be latched into a first latch associated with row 312a. The short exposure pixel data in the latch may be transferred to the ADC allocated to row 312a to convert the analog short exposure pixel data to digital pixel data that can be subsequently stored and processed digitally. Because the ADC may process pixel data that has been latched, in some aspects, the ADC may not process or access or alter active pixel data in the pixels of row 312a. Accordingly, in some aspects, while the ADC is processing the latched data, the pixels in row 312a may not be reset and instead may continue to be exposed and therefore continue to update their pixel data based on the continued exposure. When a long exposure time T2 is reached for row 312a, the pixel data in each of the pixels of row 312a may again be latched into a second latch associated with row 312a. The long exposure pixel data in the latch may be transferred to the ADC allocated to row 312a to convert the analog long exposure pixel data to digital pixel data that can be subsequently stored and processed digitally. This process may be performed for each row. In such aspects in which every row of pixel array 310 may be associated with two latches, one for capturing short exposure pixel data after time T1 and another for capturing long exposure pixel data after time T2, and one ADC, the pixel data read out time for a row may correspond to the latching time required by a latch plus the AID conversion time required by an ADC.

In another aspect, every row of pixel array 310 may be associated with two latches and two ADCs, one latch and ADC for capturing and converting short exposure pixel data. after time T1 and another latch and ADC for capturing and converting long exposure pixel data after time T2. In such an aspect, when a short exposure time T1 is reached for a particular row, such as, for example, row 312a, the pixel data in each of the pixels of row 312a may be latched into a first latch associated with row 312a. The short exposure pixel data in the first latch may be transferred to the first ADC allocated to row 312a to convert the analog short exposure pixel data to digital pixel data that can be subsequently stored and processed digitally. In some aspects, while the ADC is processing the latched data, the pixels in row 312a may not be reset and instead may continue to be exposed and therefore continue to update their pixel data based on the continued exposure. When a long exposure time T2 is reached for row 312a, the pixel data in each of the pixels of row 312a may again be latched into a second latch associated with row 312a, The long exposure pixel data in the second latch may be transferred to the second ADC allocated to row 312a to convert the analog long exposure pixel data to digital pixel data that can be subsequently stored and processed digitally. This process may be performed for each row. In such aspects in which every row of pixel array 310 may be associated with two latches and two ADCs, the pixel data read out time for a row may correspond to the latching time required by a latch plus the A/D conversion time required by an ADC.

in yet another aspect, every row of pixel array 310 may be associated with two latches, one latch for capturing short exposure pixel data after time T1 and another latch for capturing long exposure pixel data after time T2. In addition, only two ADCs may be included for the entire pixel array 310, one ADC for converting short exposure pixel data from whichever row most recently captured short exposure pixel data and another ADC for converting long exposure pixel data from whichever row most recently captured long exposure pixel data. In such an aspect, when a short exposure time is reached for a particular row, such as, for example, row 312a, the pixel data in each of the pixels of row 312a may be latched into a first latch associated with row 312a, The short exposure pixel data in the first latch may be transferred to the first ADC allocated to pixel array 310 to convert the analog short exposure pixel data to digital pixel data that can be subsequently stored and processed digitally. In some aspects, while the ADC is processing the latched data, the pixels in row 312a may not be reset and instead may continue to be exposed and therefore continue to update their pixel data based on the continued exposure. When a long exposure time T2 is reached for row 312a, the pixel data in each of the pixels of row 312a may again be latched into a second latch associated with row 312a. The long exposure pixel data in the second latch may be transferred to the second ADC allocated to pixel array 310 to convert the analog long exposure pixel data to digital pixel data that can be subsequently stored and processed digitally. This process may be performed for each row. Accordingly, in some aspects, while the first ADC may be converting short exposure pixel data from a first row, the second ADC may be converting long exposure pixel data from a second row. In such aspects in which every row of pixel array 310 may be associated with two latches while only two ADCs may be included for the entire pixel array 310, the pixel data read out time for a row may correspond to the latching time required by a latch plus the AID conversion time required by an ADC.

In some aspects, every row of pixel array 310 may be associated with only a single latch to latch short exposure pixel data after time T1. A separate latch to latch long exposure data after time T2 may be excluded. In such an aspect, as before, when a short exposure time T1 is reached for a particular row, such as, for example, row 312a, the pixel data in each of the pixels of row 312a may be latched into a latch associated with row 312a and then transferred to an ADC to convert the analog short exposure pixel data to digital pixel data that can be subsequently stored and processed digitally. When a long exposure time T2 is reached for row 312a, the pixel data in each of the pixels of row 312a may be directly transferred to an ADC, without first being latched, to convert the analog long exposure pixel data to digital pixel data that can be subsequently stored and processed digitally.

In some aspects, such as the aspects illustrated in FIG. 3A or 3B, the pixels from which the long exposure pixel data is obtained may be the same pixels from which the short exposure pixel data is obtained. For example, as illustrated in FIG. 3A or 3B, short exposure pixel data and long exposure pixel data may be obtained from all the pixels in pixel array 310. In other words, in aspects of this disclosure, some pixels may not be designated for only the capturing of short exposure pixel data while other pixels are designated for only the capturing of long exposure pixel data. Instead, in aspects of the disclosure, pixels may be used to obtain both short exposure pixel data and long exposure data.

Similarly, in some aspects, such as the aspects illustrated in FIG. 3A or 3B, the plurality of pixels that are exposed may include substantially all pixels available in the device. That is, a pixel array used for capturing an image, such as pixel array 310, may represent all or substantially all pixels available in a camera device. For example, in the aspects illustrated in FIG. 3A or 3B, the camera device includes a 16-pixel pixel array 310 and all 16 pixels are used for the capturing of short exposure data and long exposure data. In other aspects, the pixel array of a camera device may include a different number of pixels and the camera device may use all or substantially all of the pixels of the pixel array to capture both short exposure data and long exposure data.

According to some aspects, such as the aspects illustrated in FIG. 3A or 3B, the short exposure pixel data and the long exposure pixel data may be obtained from a single continuous exposure of the plurality of pixels. In other words, in timing diagrams 320 or 360, after the short exposure time T1 has elapsed at point 330, exposure of one or more rows of pixel array 310 may continue without stopping at point 330. Instead, at point 330 of timing diagrams 320 or 360, the camera device may read out the instantaneous values of the pixels in one or more rows of pixel array 310 while exposure continues. In other words, at point 330, a snapshot of the values of all pixels in one or more rows of pixel array 310 may be read out while exposure continues until long exposure time T2 has elapsed.

In certain aspects, the plurality of pixels, such as pixel array 310 in FIG. 3A or 3B, may be reset. For example, in one aspect of the disclosure, the plurality of pixels, i.e., one or more or all rows of the pixel array 310, may be reset only after short exposure data and long exposure data has been obtained from the plurality of pixels. In other words, the values of one or more or all rows of pixel array 310 may be reset at point 340 of timing diagrams 320 or 360 after long exposure time T2 has elapsed and long exposure pixel data has been obtained from one or more or all rows of pixel array 310. In another aspect of the disclosure, one or more or all rows of pixel array 310 may be reset before short exposure data and long exposure data has been obtained from one or more or all rows of pixel array 310. For example, one or more or all rows of pixel array 310 may be reset before time T0 or at time T0 right before exposure has been started. In yet other aspects of the disclosure, one or more or all rows of pixel array 310 may be reset before short exposure pixel data and long exposure pixel data has been obtained from one or more or all rows of pixel array 310, such as at or near time T0, and/or reset after short exposure pixel data and long exposure pixel data has been obtained from one or more or all rows of pixel array 310, such as at or near point 340 on timing diagram 320 or 360. One or more or all rows of pixel array 310 are not reset at any point after short exposure pixel data has been obtained but before long exposure pixel data has been obtained. That is, one or more or all rows of pixel array 310 are not reset between points 330 and 340 on timing diagram 320 or 360.

When one or more or all rows of pixel array 310 are reset at or near point 340 after long exposure time T2 has elapsed and long exposure pixel data has been obtained from one or more or all rows of pixel array 310, before the plurality of pixels, e.g., one or more or all rows of pixel array 310, are reset, the captured short exposure pixel data and the captured long exposure pixel data may be output for image and/or video post processing. For example, in some aspects, before resetting one or more or all rows of the pixel array 310 at or near point 340 on timing diagrams 320 or 360, the captured short exposure pixel data and the captured long exposure pixel data may be output from one or more ADCs, for example in a serial or parallel manner, to a memory of the camera device so that the processor(s) of the camera device may access the short exposure pixel data and the long exposure pixel data for image and/or video processing. In some aspects of the disclosure, the short exposure pixel data may be output to memory at or near time 330 after short exposure pixel data has been obtained from one or more or all rows of the pixel array 310 and the long exposure pixel data may be output to memory at or near time 340 after long exposure pixel data has been obtained from one or more or all rows of the pixel array 310. In some aspects, the camera device may, for example under control of processor 110, combine the short exposure pixel data with the long exposure pixel data to generate an HDR image or an HDR video. In other words, a processor of the camera device may access the short exposure pixel data and the long exposure pixel data and perform image processing on the short exposure pixel data and the long exposure pixel data to generate an HDR image or an HDR video. In some aspects, processing may include identifying the short exposure data and the long exposure data using a data type (DT) parameter in accordance with a standardized protocol, such as the MIPI CSI-2 standardized protocol.

In timing diagrams 320 in FIG. 3A, the exposure start time T0 is the same for all rows 312 of pixel array 310, the short exposure time T1 is the same for all rows 312 of pixel array 310, and the long exposure time T2 is the same for all rows 312 of pixel array 310. Thus, short exposure data is obtained from all pixels in pixel array 310 at approximately the same time and long exposure data is obtained from all pixels in pixel array 310 at approximately the same time. In other aspects, any one of exposure start time T0 (see FIG. 3B), short exposure time T1, and long exposure time T2 may be different for a different row. For example, in the aspect illustrated in FIG. 3B, exposure start time T0 in timing diagram 360a for row 312a of pixel array 310 may be different than exposure start time T0 in timing diagram 360d for row 312d of pixel array 310. Therefore, in such an aspect, although both short exposure data and long exposure data is still obtained from every pixel, the capturing of the short exposure data and the capturing of the long exposure data may occur at different times for the pixels in rows 312a and 312d because their exposure start times T0 are different. Similarly, the short exposure times T1 and long exposure times T2 for rows may be different. Regardless of whether the exposure start times T0, the short exposure times T1, and/or the long exposure times T2 are the same or vary for different rows, both short exposure data and long exposure data may be obtained from each pixel.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof if implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

Although the present disclosure and advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of high dynamic range (HDR) imaging, comprising:
starting, by a processor, exposure of a plurality of pixels available in a device;
capturing, by the processor, pixel data from the plurality of pixels after a first time period has elapsed to obtain short exposure pixel data; and
capturing, by the processor, pixel data from the plurality of pixels after a second time period, longer than the first time period, has elapsed to obtain long exposure pixel data.

2. The method of claim 1, wherein the pixels from which the long exposure pixel data is obtained are the same pixels from which the short exposure pixel data is obtained.

3. The method of claim 1, wherein the plurality of pixels that are exposed comprises substantially all pixels available in the device.

4. The method of claim 1, further comprising resetting the plurality of pixels, wherein the plurality of pixels are reset only after short exposure data and long exposure data has been obtained from the plurality of pixels.

5. The method of claim 1, wherein the short exposure pixel data and the long exposure pixel data is obtained from a single continuous exposure of the plurality of pixels.

6. The method of claim 1, further comprising outputting the captured short exposure pixel data and the captured long exposure pixel data for image or video post processing before resetting the plurality of pixels.

7. The method of claim 1, further comprising combining the short exposure pixel data with the long exposure pixel data to generate an HDR image or an HDR video.

8. An apparatus configured for performing high dynamic range (HDR) imaging, comprising:
means for starting exposure of a plurality of pixels available in a device;
means for capturing pixel data from the plurality of pixels after a first time period has elapsed to obtain short exposure pixel data; and
means for capturing pixel data from the plurality of pixels after a second time period, longer than the first time period, has elapsed to obtain long exposure pixel data.

9. The apparatus of claim 8, wherein the pixels from which the long exposure pixel data is obtained are the same pixels from which the short exposure pixel data is obtained.

10. The apparatus of claim 8, wherein the plurality of pixels that are exposed comprises substantially all pixels available in the device.

11. The apparatus of claim 8, further comprising means for resetting the plurality of pixels, wherein the plurality of pixels are reset only after short exposure data and long exposure data has been obtained from the plurality of pixels.

12. The apparatus of claim 8, wherein the short exposure pixel data and the long exposure pixel data is obtained from a single continuous exposure of the plurality of pixels.

13. The apparatus of claim 8, further comprising means for outputting the captured short exposure pixel data and the captured long exposure pixel data for image or video post processing before resetting the plurality of pixels.

14. The apparatus of claim 8, further comprising means for combining the short exposure pixel data with the long exposure pixel data to generate an HDR image or an HDR video.

15. A non-transitory computer-readable medium having program code recorded thereon for performing high dynamic range (HDR) imaging, the program code comprising:
program code executable by a computer for causing the computer to:
start exposure of a plurality of pixels available in a device;
capture pixel data from the plurality of pixels after a first time period has elapsed to obtain short exposure pixel data; and
capture pixel data from the plurality of pixels after a second time period, longer than the first time period, has elapsed to obtain long exposure pixel data.

16. The non-transitory computer-readable medium of claim 15, wherein the pixels from which the long exposure pixel data is obtained are the same pixels from which the short exposure pixel data is obtained.

17. The non-transitory computer-readable medium of claim 15, wherein the plurality of pixels that are exposed comprises substantially all pixels available in the device.

18. The non-transitory computer-readable medium of claim 15, wherein the program code further comprises program code for causing the computer to reset the plurality of pixels, wherein the plurality of pixels are reset only after short exposure data and long exposure data has been obtained from the plurality of pixels.

19. The non-transitory computer-readable medium of claim 15, wherein the short exposure pixel data and the long exposure pixel data is obtained from a single continuous exposure of the plurality of pixels.

20. The non-transitory computer-readable medium of claim 15, wherein the program code further comprises program code for causing the computer to output the captured short exposure pixel data and the captured long exposure pixel data for image or video post processing before resetting the plurality of pixels.

21. The non-transitory computer-readable medium of claim 15, wherein the program code further comprises program code for causing the computer to combine the short exposure pixel data with the long exposure pixel data to generate an HDR image or an HDR video.

22. An apparatus configured for performing high dynamic range (HDR) imaging, the apparatus comprising:
a memory; and
at least one processor coupled to the memory, wherein the at least one processor is configured to:
start exposure of a plurality of pixels available in a device;
capture pixel data from the plurality of pixels after a first time period has elapsed to obtain short exposure pixel data; and
capture pixel data from the plurality of pixels after a second time period, longer than the first time period, has elapsed to obtain long exposure pixel data.

23. The apparatus of claim 22, wherein the pixels from which the long exposure pixel data is obtained are the same pixels from which the short exposure pixel data is obtained.

24. The apparatus of claim 22, wherein the plurality of pixels that are exposed comprises substantially all pixels available in the device.

25. The apparatus of claim 22, wherein the at least one processor is further configured to reset the plurality of pixels, wherein the plurality of pixels are reset only after short exposure data and long exposure data has been obtained from the plurality of pixels.

26. The apparatus of claim 22, wherein the short exposure pixel data and the long exposure pixel data is obtained from a single continuous exposure of the plurality of pixels.

27. The apparatus of claim 22, wherein the at least one processor is further configured to output the captured short exposure pixel data and the captured long exposure pixel data for image or video post processing before resetting the plurality of pixels.

28. The apparatus of claim 22, wherein the program code further comprises program code for causing the computer to combine the short exposure pixel data with the long exposure pixel data to generate an HDR image or an HDR video.
